(19) United States
(12) Patent Application Publication
(10) Pub. No.: US 2016/0072937 A1
(43) Pub. Date: Mar. 10, 2016

(54) Auto reminder, alarm and response system and method

(71) Applicant: James Albert Gavney, JR., San Mateo, CA (US)

(72) Inventor: James Albert Gavney, JR., San Mateo, CA (US)

(21) Appl. No.: 14/756,471

(22) Filed: Sep. 8, 2015

Related U.S. Application Data
(60) Provisional application No. 62/070,789, filed on Sep. 8, 2014.

(51) Int. Cl. H04M 1/64; H04M 1/725; H04W 4/12

(52) U.S. Cl. CPC H04M 1/642; H04W 4/12; H04M 1/72547

(57) ABSTRACT

A auto-response message (ARM) system is disclosed. In operation a sender generates an executable ARM and sends the executable ARM to one or more contacts, receivers or recipients. When one more contacts, receivers or recipients accepts the ARM, the ARM is executed to remind the or more contacts, receivers or recipients of an activity, event or some other time sensitive subject. In further embodiments, a user sets their smart device to send and ARM responses to incoming texts or phone calls based on the user's activity.

### RELATED APPLICATION

This patent application claims priority under 35 U.S.C. 119 (e) of the U.S. Provisional Patent Application Ser. No. 62/070,789, filed Sep. 8, 2014, and titled “REMINDER AND ALARM SYSTEM AND METHOD.” The U.S. Provisional Patent Application Ser. No. 62/070,789, filed Sep. 8, 2014, and titled “REMINDER AND ALARM SYSTEM AND METHOD” is hereby incorporated by reference.

### FIELD OF THE INVENTION

This invention relates automated reminder, alarm and response systems and methods. More particularly, the present invention relates systems and methods that initiate automated reminders, alarms over a wireless network.

### BACKGROUND OF THE INVENTION

Texting has become one of the most pervasive forms of electronic communication. It has been speculated that texting will replace conventional e-mail service. Further, many people prefer to use texting as a method of communicating because it is fast, does not require an immediate response and limits the amount of interaction necessary to communicate small amounts of information or short messages.

Texting generally refers to Short Message Service (SMS). SMS is a text messaging service component of phone, Web, or mobile communication systems. It uses standardized communication protocols to allow fixed line or mobile phone devices to exchange short text messages. However, the lines are getting blurred between SMS, e-mail and other communication protocols. For example, Twitter and Tumbler each have their own communication protocol that allow for users to quickly communicate between each other. The main difference is that SMS is communicating over a cellular network and other communication protocols are usually operating over the internet directly of over the internet through a cellular network. The present invention is primarily directed for use within the SMS protocols, but also has applications in other communication protocols including TCP/IP (the Internet), SMTP (email), HTTP (the web), and those newer protocols used by Twitter, Tumbler and others.

### SUMMARY OF THE INVENTION

The present invention includes an application that allows a user to send a text to a recipient or recipients with an attached picture file, audio file or video file (data files) attached to it. The picture file, the audio file or the video files are coded for or designated with an execution time or execution times. The picture file, the audio file or video file is selected from a user created library (a sent folder) of picture files, audio files or video files. The execution time or execution times of the picture files, audio files or video files can be changed or selected by the user. Embedded within or attached to the picture file, the audio file or video file is an “accept icon” and a “decline icon” and the coded execution time or execution times. If the recipient or recipients select the accept icon, the picture file, the audio file or video file is downloaded to a recipient library “received folder” and an automatic reminder or alarm is generated that displays the picture file or plays the audio file or video file on the recipient or recipients smart phones at the execution time or execution times selected.

This applications similar to an e-mail invite and reminder program that automatically synchronized with a corresponding e-mail calendar. The main differences between the e-mail system and the text system described above are that the reminders or alarms are delivered to the recipient or recipients via text messaging; the reminders or alarms are auto-executed picture files, audio files or video files that play at the selected execution time or selected execution times on a smart phone; and the picture files, audio files or video files are personalized by user preferences and not restricted to text or simple graphics. Like an e-mail account the sent folder and the received folders preferably can be edited to delete.

The application can in some ways be considered to be the anthesis of the “snap shot” application, where pictures are sent and then disappear after a time frame. While the application is described as displaying or playing the data files from and on the recipients smart phones or texting devices, the application could be configured to automatically send and resend the data files at a selected send time or send times. In this configuration, only the user or sender would require to host the application software.

You can currently attach picture files, audio files or video files to a text message and open or execute them. But the picture files, audio files or video files are not automatically sent, are not automatically saved, are not automatically displayed or played with a synchronized clock according to selected execution times or send times.

Why would anyone want to use this application? Besides the reasons that will become apparent by way of examples below, text messaging is going to become the new e-mail and the smart phone will become new primary computer, especially with the increased band availability and the corresponding reduced cost of transferring data.

### Example 1

I (the user/sender) send my sister and brother (the recipients) a group text message that says “Hey guys this is a reminder so that you don't forget Uncle Ben's Birthday on June 5^{th}. Attached to the text message is a picture file of Uncle Ben blowing out candles from last years birthday and the accept and decline icons. Because my sister and brother are very forgetful, I have selected execution times of 12:00 pm, June 1, 2,3, 4 and 5^{th}. Assuming my sister and brother want to remember Uncle Ben's birthday, they both select accept. The executable picture file of Uncle Ben is downloaded to their received folder and at 12:00 pm, June 1, 2,3, 4 and 5^{th} a picture of Uncle Ben blowing out the candles shows up on screens of their respective smart phones.

### Example 2

I (the user/sender) send John (the recipient) a text. The text reads, for example, John I have a party at my house at 8:00 pm on July 27^{th}. Do you want to join? There is a pre-recorded audio file that I have recorded and selected from my library to attached to the text message with an execution time of, for example, 5:00 pm, July 27^{th}. The pre-recorded audio file for example says “hey John, this is James reminding you its time to put your party hat on and don't forget you famous guacamole dish.” When the text message is received by John, there is an accept and decline icon embedded within or linked to the audio file. John can respond with no, select the decline icon or do nothing and the audio file will not download or be saved. Alternatively, John can respond yes and/or simply select accept. The audio file attached to the text message will download into a John's received folder and the audio file will play at the designated execution time of 5:00 pm.

### Example 3

I (the user/sender) send myself (the recipient) a text. The text reads, for example, it is time for your annual physical. There is a pre-recorded video file that I have selected from the internet and saved in my sent folder that has Frankenstein being worked on by a mad scientist. I have attached the Frankenstein video file to the text message that I sent myself with an execution time of, for example, 1:00 pm, Jan. 1, 2014, 2015 and 2016. When I receive my message I simply select accept. The audio file attached is downloaded to my received folder and plays at the designated execution times of Jan. 1, 2014, 2015 and 2016.

Preferably, files can be selected and execution times or send times can be assigned without leaving the texting application.

In further embodiments of the invention the application includes an auto-response function to place a smart phones or texting device in an auto response mode. In the auto-response mode a user can select an auto response message (ARM) from set or library of ARMs. Alternatively, a user can create an ARM from within the program or attach a data file, (text, audio or image) from data files existing on his or her smart device. When a text or a phone call is received from the selected one or more contacts, that application automatically send the selected or created ARM to the one or more selected contacts via text. The application preferably has a simple select all contacts function that will cause the smart-phone or texting device sent the selected or created ARM via a text to any contacts within his or her contact list that send a text or places a phone call to the user's smart-phone or texting device. The application can even be programmed to ignore or auto respond to incoming text or phone call that correspond to device and people not listed on a contact list.

### Example 1

A user is driving. The user can place his or her smart phone in auto-response mode with the selected or generated message being, for example. “I am driving right now.” If the user has selected the all contacts function, this message will be automatically sent via text to any contact within his or her contact list that sends a text and/or places a call to the user's smart phone or texting device.

### Example 2

A user is at a job interview, but only wants a selected number of his or her contacts to know. The user can selected or created an auto response, that reads, for example, “I am at a job interview.” From the user's contacts list, the user can select any number of contacts and when any of the selected contacts sends a text and/or places a phone call to the user's smart-phone or texting device, this message will be automatically sent via text to the contacts that is texting or calling.

### Example 3

The user is taking a walk in a beautiful park. The user can take a picture of his or her location. The users can place the picture into his or her auto response file. When any person texts or calls, that system will automatically text the number or contact associated with the incoming text or call the picture of the beautiful park.

It will be clear to one skilled in the art form the examples above as the description below that any number of auto-response scenarios can be created with using the system and method of the present invention. Further, the system and method of the present invention can be employed using a software application or firmware on a single user that initiates auto-responses or can be employed using group-user software or firmware. Wherein, group-user software or firmware is employed a greater complexity of auto-response scenarios can be created.

### DESCRIPTION OF DRAWINGS

FIG. 1 shows a schematic representation of executable calendar, contacts and auto-reminder pages and files accessible from a smart-phone, in accordance with the embodiments of the invention.

FIG. 2 shows a schematic representation of smart-phones communicating over a cellular network, in accordance with the embodiments of the invention.

FIG. 3 shows a schematic representation of a text message format with an embedded reminder icon and calendar icon that is sent to a contact with a decline icon, an accept icon and a review icon, in accordance with the embodiments of the invention.

FIG. 4 shows a schematic representation of a reminder message that appears on a text message of the contact that has accepted the received message sent in FIG. 3, in accordance with the embodiments of the invention.

FIG. 5 shows an auto pop-up image that appears on a screen of smart device of a contact that has accepted the received message sent in FIG. 3, in accordance with the embodiments of the invention.

FIG. 6 shows a schematic representation of a contact menu window and an auto-response menu accessible through a program icon on a screen of a smart-phone, in accordance with the embodiments of the invention.

FIG. 7 shows a schematic representation of a group of contacts configured to receive an auto-response over a cellular network, in accordance with the embodiments of the invention.

FIG. 8 shows schematic representation of a auto-response icon embedded within a text message and an auto-response that is initiated by and incoming text message, in accordance with the embodiments of the invention.

FIG. 9 shows schematic representation of a auto-response icon embedded within a text message and an auto-response that is initiated by and incoming phone call, in accordance with the embodiments of the invention.

FIG. 10 shows a block-flow diagram outlining steps to generate an auto-response message (ARM) and distributing the auto-response message to a list of selected recipients or contacts, in accordance with the method of the invention.

FIG. 11 shows a block-flow diagram outlining steps to distribute an auto-response message (ARM) to a list of recipients from a contact list based on a user's activity, in accordance with the method of the invention.

### DETAILED DESCRIPTION OF THE INVENTION

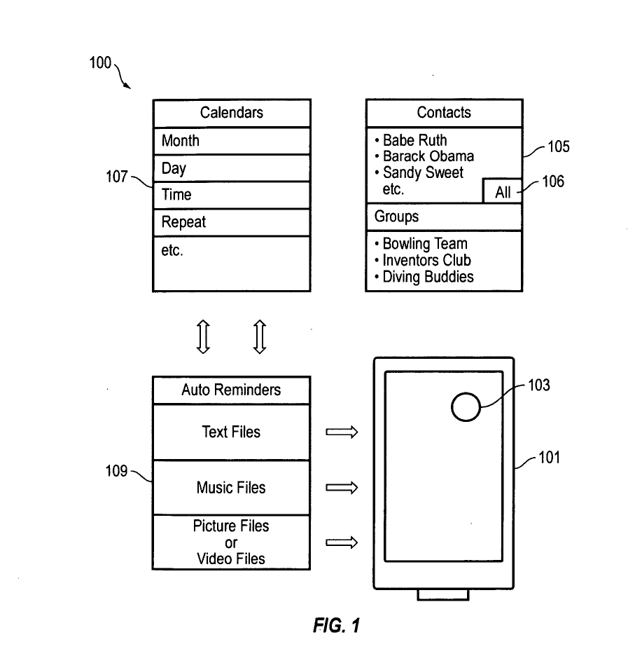

FIG. 1 shows a schematic representation 100 of executable calendar 107, contacts list 105 and auto-reminder pages and files 109 accessible from a smart-phone 103. The smart phone runs application software executable through an icon 103. The application software is configured to allows the executable calendar 107, contacts list 105 and auto-reminder pages and files 109 to collectively to generate an executable ARM.

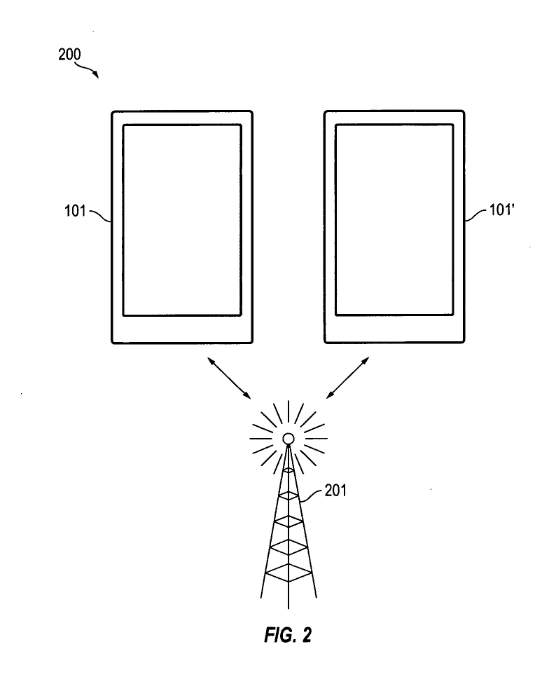

FIG. 2 shows a schematic representation 200 of smart-phones 101 and 101′ communicating over a cellular network 201. It will be clear to on skilled in the art that the system and method of the present invention is operable over a cellular network 201, a local area network, or any other suitable wireless network.

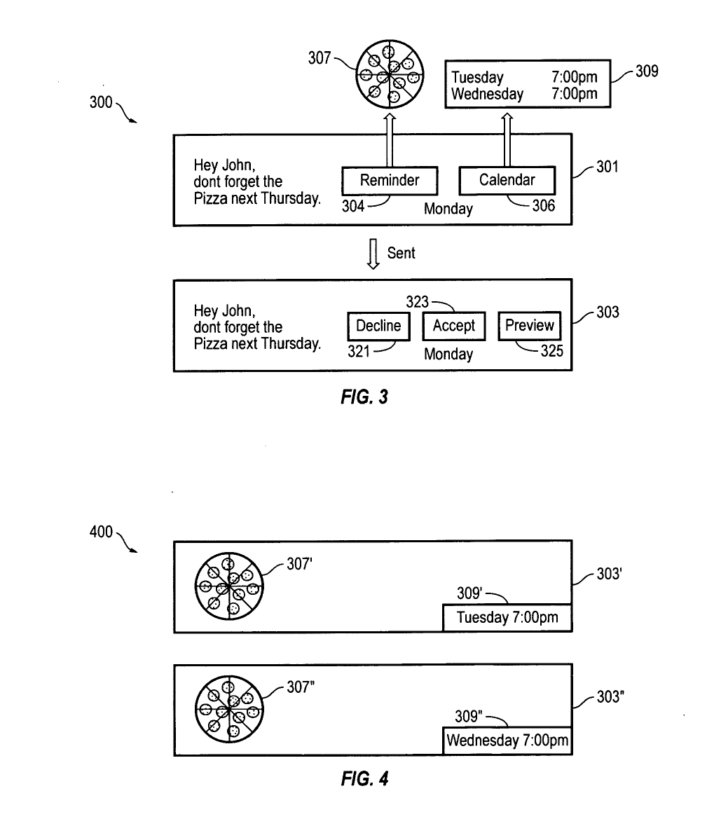

FIG. 3 shows a schematic representation 300 of a text message format 301 with an embedded reminder icon 304 and calendar icon 306. In operation, a sender generates a text message such as “Hey John, don't forget the Pizza next Thursday.” The sender selects am image 307, such as a pizza, from their auto-reminder pages and files 109 by selecting reminders. The sender then selects a frequency and time 309 from their executable calendar 107. The sender then send the messages to a receiver over a suitable wireless network. The receiver receives the text message 303 coded with an executable ARM. The text message 303 includes a decline icon 321, an accept icon 323 and as preview icon 325. The receiver can decline the ARM, in which case the ARM is not executed, accept the ARM, in which case the ARM is executed and/or preview the ARM, in which case the receiver can view the images 307 and the frequency and time 309.

FIG. 4 shows a schematic representation 400 of reminder messages 303′ and 303″ that appears on a text message of the contact that received (the receiver) and accepts the message 301 sent in FIG. 3. In operation, when the receiver accepts the ARM, the image 307 appears 307′ and 307″ in corresponding texts 303′ and 303″ that are automatically generated at the frequency and times 309 and 309″ corresponding the frequency and times 309 selected by the sender. While the example above uses an image 307 as the executable reminder file, it will be clear to one skilled in the art that the executable reminder file can also be an audio file or a video file that is executed or played at the frequency and times 309 selected by the sender. Also, while the present example illustrates the use of ARMs between multiple users over a wireless network, the system and method can also be used to generate personal ARMs of self-ARMs on a single user device or smart phone, and thus would not require a network.

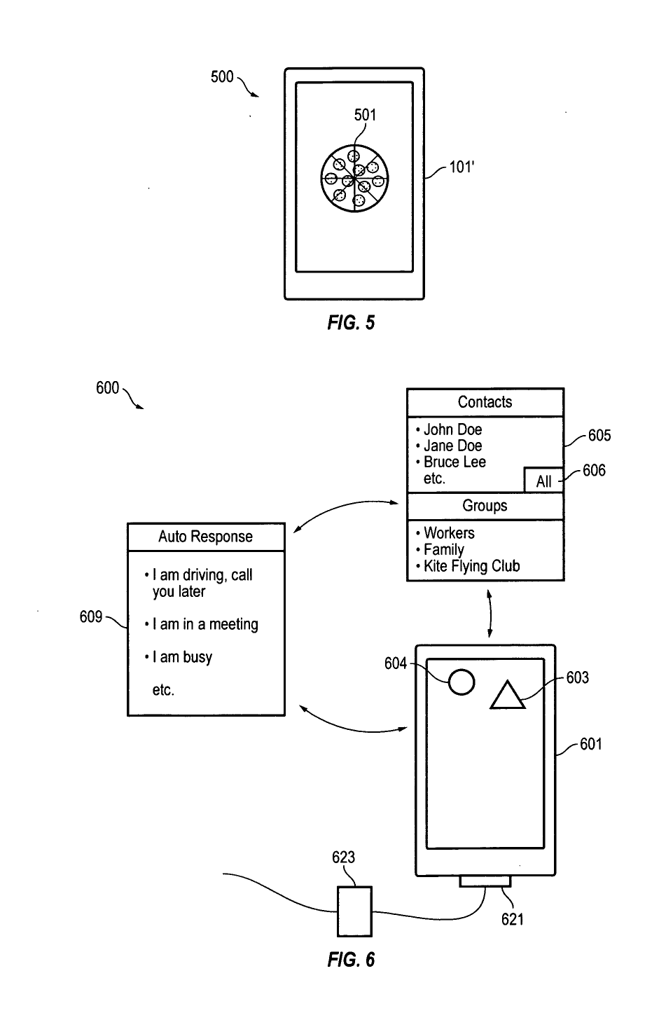

FIG. 5 shows a view 500 of an auto pop-up image 501 that appears on a screen or a smart device 101′ of contact or receiver that has accepted the received the message sent in FIG. 3. In accordance with the embodiments of the invention the executable reminder file is viewable or played at the frequency and times 309 selected by the sender when the contact or receiver is not in text mode. Further, preferably when the contact or receiver accepts the ARM, the executable reminder file (image file, audio file and/or video) is automatically saved in a storage file that the contact or receiver can accesses at a later date. In current text system image files, audio files and video files that are attached to texts are not automatically saved when they are received. To properly enable the peer-to-peer ARM system and method described above, both the sender and receiver are required to have executable ARM software or firmware that is stored and run on their smart-devices. In the example below, there no need for both the sender and the receiver to have executable ARM software or firmware that is stored their smart-devices, and only the sender is required to have a simplified version of executable ARM software or firmware.

In the previous example, a sender generates an ARM and sends that ARM to a contact or receiver. When the contact or receiver accepts the ARM, the ARM is executed to remind the contact or receiver of an activity, an event of some other time sensitive subject. In the example below, a user sets their smart device to provide automatic responses to incoming texts or phone calls. FIG. 6 shows a schematic representation 600 of a contact menu window 605, and an auto-response menu 609 accessible through a program icon 603 on a screen of a smart-device, such as a smart phone. In operation a user opens the ARM software or firm-ware through the program icon 603. The user then selects a message an auto-response menu 609 and selects one or more contacts from the contact menu window 605. The ARM software or firmware can be set active or on for pre-selected period of time though a calendar or clock menu similar to the calendar menu 107 shown in FIG. 1. Preferably, the ARM software or firmware generates and indicator 604 to show that software or firmware is on. Note that the user can select individual contacts, groups of contacts or all contacts 606 from the contact menu window.

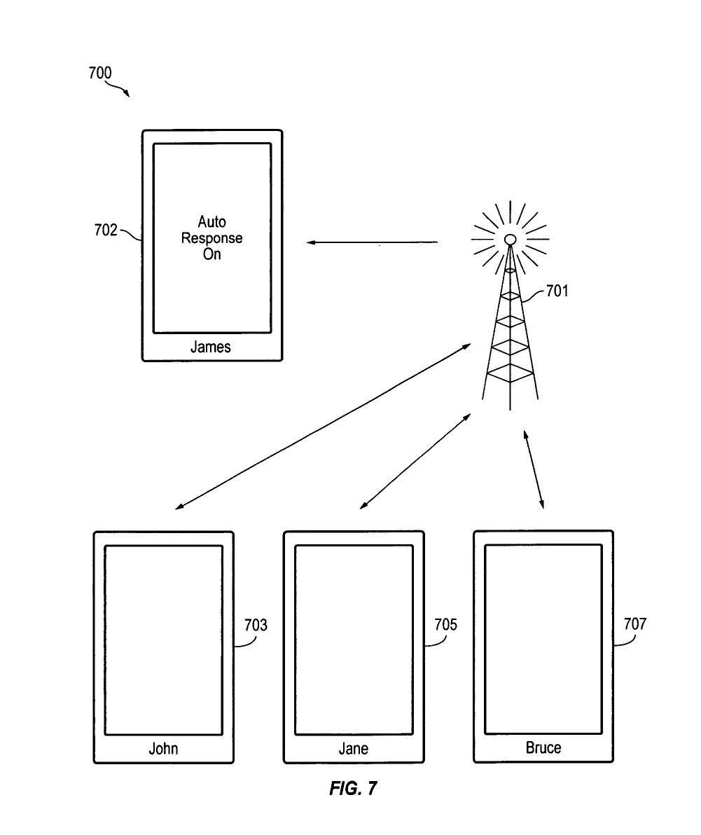

FIG. 7 shows a schematic representation 700 of a group of contacts, John, Jane and Bruce, configured to receive an auto-response over a cellular network 701 from James. In operation James has selected John, Jane and Bruce from the contact menu widow 605 to receive an automatic response from his smart device 702, when John, Jane and/or Bruce text and/or call from their respective smart devices 703, 705 and 707.

FIG. 8 shows schematic representation 800 of a auto-response icon 805 embedded within a text message 801 and a auto-response that is initiated by and incoming text message or a call. In this example, James receive and incoming text from Jane that says “What's up James? Stop by for a beer.” James has selected an auto response 803 that says “I am driving I will call you later.”

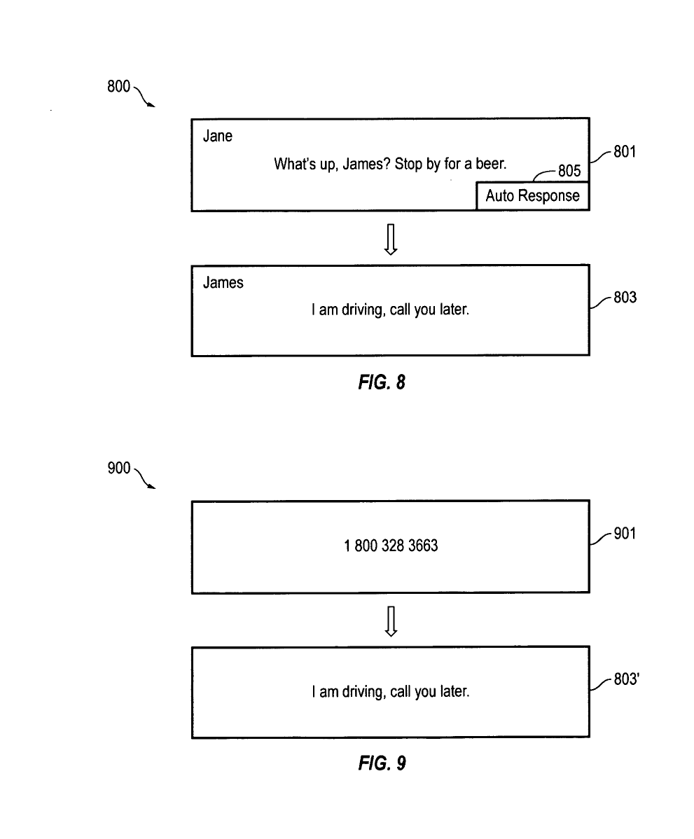

FIG. 9 shows schematic representation 900 of a auto-response embedded within a text message auto-response 803 that is initiated in response to an incoming phone call 901 (1-800-328-3663) The user can set the system to send and auto-response to any combination of incoming texts or phone calls.

Referring back to FIG. 6, the system can include a periphery device 623 that plugs into the smart device through a charging port 621, for example. The periphery device automatically initiates the auto-response program and can automatically select the auto-response. For example, the periphery device and be a car cell phone charger that automatically initiates an “I am driving, call you later” response any time the smart device 601 is plugged into the periphery device 623 through the charging port 621. In further embodiments of the invention, the system works with other sensing technology, such as accelerometers and determine a user's activity to generate or set up and appropriate auto-response. For example, if a user is exercising with his or her smart device, the system can initiates and auto-response that says “I am exercising, will call you later.” It will be clear to on skilled in the art that the auto-response can be a text file, a audio file, a video file or a combinations thereof.

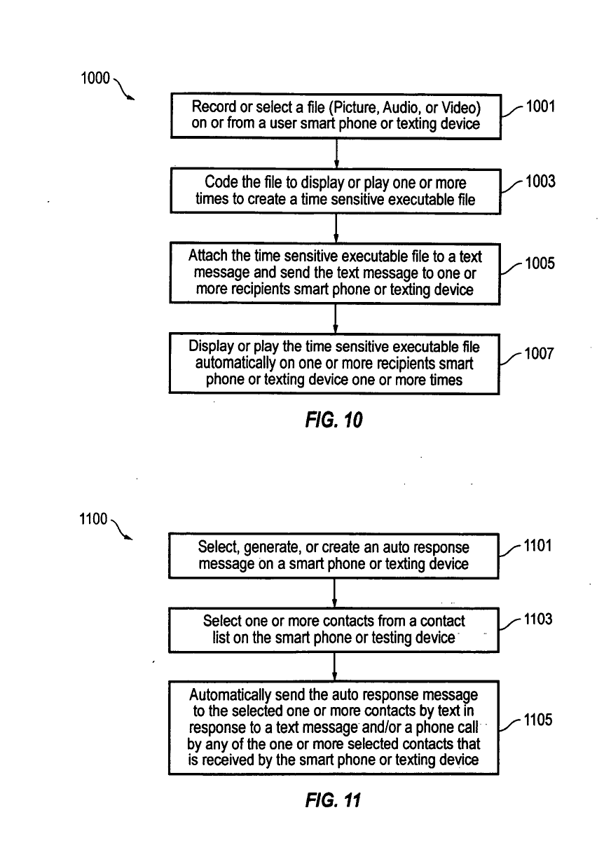

FIG. 10 shows a block-flow diagram 1000 outlining steps to generate an auto-response message (ARM) and directly distribute the auto-response message to a list of selected recipients (receivers or contacts). In the step 1001, a an auto-response file is selected on or generated from a users smart device. In the step 1003, the selected auto-response file is coded to be executed according to selected times or frequencies based on a clock or calendar. Then in the step 1005 file is then sent to one or more contacts and in the step 1007 the auto response file is executed and the selected times or frequencies on the contacts smart device.

FIG. 11 shows a block-flow diagram 1100 outlining steps to distribute and auto-response message (ARM) to a list of recipients from a contact list. In the step 1101 an auto-response is selected on or generated from a users smart device. In the step 1103, one or more contacts are selected from the a list of contacts on the smart device. The in the step 1105, the auto response is automatically sent to the one or more selected contacts, when the corresponding one or more selected contacts calls or text the users smart device.

What is claimed is:

1. A system comprising a smart device for operating software configured to automatically send a message that includes at least one of a picture file and an audio file over a network in response to an incoming call or text.

2. The system of claim 1, wherein the smart device is configured to detect a user activity and automatically select the message based on the detected user activity.

3. The system of claim 1, wherein the software includes a contact list, wherein the message is sent to selected contacts from the constant list in response to the incoming call or text from the selected contacts.

4. A system for creating a executable automatic reminder on a smart device and sending the executable automatic reminder over a network to a receiving smart device, wherein the executable automatic reminder is executed according to a calender, wherein the executable automatic reminder includes at least one of a picture file and an audio file.

5. A system for detecting a user activity and automatically sending a message to a list of contacts from a smart device based on the detected user activity.

6. The system of claim 5, wherein the message includes at least one of a picture file and an audio file.
